(19) United States
(12) Patent Application Publication
(10) Pub. No.: US 2025/0062811 A1
(43) Pub. Date: Feb. 20, 2025

(54) QUERY-BASED CHANNEL STATE INFORMATION FEEDBACK DECODING FOR CROSS-NODE MACHINE LEARNING

(71) Applicant: QUALCOMM Incorporated, San Diego, CA (US)

(72) Inventors: June NAMGOONG, San Diego, CA (US); Akash Sandeep DOSHI, San Diego, CA (US); Taesang YOO, San Diego, CA (US); Hyojin LEE, San Diego, CA (US)

(21) Appl. No.: 18/738,268

(22) Filed: Jun. 10, 2024

Related U.S. Application Data
(63) Continuation of application No. 18/450,821, filed on Aug. 16, 2023.

(51) Int. Cl. H04B 7/06; H04B 7/0456; H04W 72/0457

(52) U.S. Cl. CPC H04B 7/0634; H04B 7/0456; H04B 7/0626; H04B 7/0639; H04W 72/0457

(57) ABSTRACT

Various aspects of the present disclosure generally relate to wireless communication. In some aspects, a user equipment (UE) may receive, from a network node, a transformer configuration that includes a transmitter neural network configured to be used to generate at least one latent vector corresponding to one or more channel state information (CSI) feedback tasks of a plurality of CSI feedback tasks associated with a transformer-based cross-node machine learning system, and transmit the at least one latent vector based at least in part on instantiating the transmitter neural network. Numerous other aspects are described.

### RELATED APPLICATION

This application is a continuation of U.S. patent application Ser. No. 18/450,821, filed Aug. 16, 2023, entitled “QUERY-BASED CHANNEL STATE INFORMATION FEEDBACK DECODING FOR CROSS-NODE MACHINE LEARNING,” which is incorporated herein by reference in its entirety.

### FIELD OF THE DISCLOSURE

Aspects of the present disclosure generally relate to wireless communication and to techniques and apparatuses for query-based channel state information feedback decoding for cross-node machine learning.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a user equipment (UE). The apparatus may include one or more memories and one or more processors coupled to the one or more memories. The one or more processors may be configured to receive, from a network node, decoder configuration information associated with a transmitter neural network configured to be used to generate at least one latent vector corresponding to one or more computation tasks of a plurality of computation tasks associated with a query-based cross-node machine learning system. The one or more processors may be configured to receive, from the network node, query configuration information associated with a query-based decoder. The one or more processors may be configured to transmit, to the network node and based at least in part on instantiation of the transmitter neural network by the UE, the at least one latent vector.

Some aspects described herein relate to an apparatus for wireless communication at a network node. The apparatus may include one or more memories and one or more processors coupled to the one or more memories. The one or more processors may be configured to transmit, to a UE, decoder configuration information associated with a transmitter neural network configured to be used to generate at least one latent vector corresponding to one or more computation tasks of a plurality of computation tasks associated with a query-based cross-node machine learning system. The one or more processors may be configured to transmit, to the UE, query configuration information associated with a query-based decoder. The one or more processors may be configured to receive, from the UE and based at least in part on instantiation of the transmitter neural network by the UE, the at least one latent vector.

Some aspects described herein relate to a method of wireless communication performed by a UE. The method may include receiving, from a network node, decoder configuration information associated with a transmitter neural network configured to be used to generate at least one latent vector corresponding to one or more computation tasks of a plurality of computation tasks associated with a query-based cross-node machine learning system. The method may include receiving, from the network node, query configuration information associated with a query-based decoder. The method may include transmitting, to the network node and based at least in part on instantiation of the transmitter neural network by the UE, the at least one latent vector.

Some aspects described herein relate to a method of wireless communication performed by a network node. The method may include transmitting, to a UE, decoder configuration information associated with a transmitter neural network configured to be used to generate at least one latent vector corresponding to one or more computation tasks of a plurality of computation tasks associated with a query-based cross-node machine learning system. The method may include transmitting, to the UE, query configuration information associated with a query-based decoder. The method may include receiving, from the UE and based at least in part on instantiation of the transmitter neural network by the UE, the at least one latent vector.

Some aspects described herein relate to a non-transitory computer-readable medium that stores a set of instructions for wireless communication by a UE. The set of instructions, when executed by one or more processors of the UE, may cause the UE to receive, from a network node, decoder configuration information associated with a transmitter neural network configured to be used to generate at least one latent vector corresponding to one or more computation tasks of a plurality of computation tasks associated with a query-based cross-node machine learning system. The set of instructions, when executed by one or more processors of the UE, may cause the UE to receive, from the network node, query configuration information associated with a query-based decoder. The set of instructions, when executed by one or more processors of the UE, may cause the UE to transmit, to the network node and based at least in part on instantiation of the transmitter neural network by the UE, the at least one latent vector.

Some aspects described herein relate to a non-transitory computer-readable medium that stores a set of instructions for wireless communication by a network node. The set of instructions, when executed by one or more processors of the network node, may cause the network node to transmit, to a UE, decoder configuration information associated with a transmitter neural network configured to be used to generate at least one latent vector corresponding to one or more computation tasks of a plurality of computation tasks associated with a query-based cross-node machine learning system. The set of instructions, when executed by one or more processors of the network node, may cause the network node to transmit, to the UE, query configuration information associated with a query-based decoder. The set of instructions, when executed by one or more processors of the network node, may cause the network node to receive, from the UE and based at least in part on instantiation of the transmitter neural network by the UE, the at least one latent vector.

Some aspects described herein relate to an apparatus for wireless communication. The apparatus may include means for receiving, from a network node, decoder configuration information associated with a transmitter neural network configured to be used to generate at least one latent vector corresponding to one or more computation tasks of a plurality of computation tasks associated with a query-based cross-node machine learning system. The apparatus may include means for receiving, from the network node, query configuration information associated with a query-based decoder. The apparatus may include means for transmitting, to the network node and based at least in part on instantiation of the transmitter neural network by the apparatus, the at least one latent vector.

Some aspects described herein relate to an apparatus for wireless communication. The apparatus may include means for transmitting, to a UE, decoder configuration information associated with a transmitter neural network configured to be used to generate at least one latent vector corresponding to one or more computation tasks of a plurality of computation tasks associated with a query-based cross-node machine learning system. The apparatus may include means for transmitting, to the UE, query configuration information associated with a query-based decoder. The apparatus may include means for receiving, from the UE and based at least in part on instantiation of the transmitter neural network by the UE, the at least one latent vector.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example operating environment associated with query-based cross-node machine learning systems for wireless communication, in accordance with the present disclosure.

FIG. 5 is a diagram illustrating an example of a query-based cross-node machine learning system utilizing a transformer decoder, in accordance with the present disclosure.

FIG. 6 is a diagram illustrating an example of a call flow associated with query-based channel state information feedback (CSF) decoding for cross-node machine learning systems for wireless communication, in accordance with the present disclosure.

FIG. 7 is a diagram illustrating an example of a query-based decoder layer, in accordance with the present disclosure.

FIG. 8 is a diagram illustrating an example of a decoder structure, in accordance with the present disclosure.

FIG. 9 is a diagram illustrating an example process performed, for example, at a UE or an apparatus of a UE, in accordance with the present disclosure.

FIG. 10 is a diagram illustrating an example process performed, for example, at a network node or an apparatus of a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects relate generally to wireless communication and more particularly to cross-node machine learning. Some aspects more specifically relate to query-based decoder designs that support machine learning for providing channel state information feedback (CSF). In some examples, a user equipment (UE) may be provided with a transmitter neural network for encoding CSF to be decoded by a receiver neural network at a network node. In some examples, the receiver neural network may include a query-based decoder, and associated query vectors, selected from among a number of available query-based decoders and query vectors. In some examples, the network node may specify reference decoder structures and queries that the UE may use to identify a best performing query vector set for use with a selected decoder.

Particular aspects of the subject matter described in this disclosure can be implemented to realize one or more of the following potential advantages. In some examples, by decoding CSF using a query-based decoder, the described techniques can be used to facilitate efficient CSF reporting due to a reduced complexity of the query-based decoder as compared to, for example, a transformer decoder. In some examples, by selecting a query-based decoder and associated query vectors from among a number of available query-based decoders and query vectors, the described techniques can be used to optimize the cross-node machine learning based on characteristics of a deployment. In some examples, by specifying reference decoder structures and queries, the described techniques can be used to facilitate optimization of a selected decoder, thereby improving decoding efficiency and accuracy.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

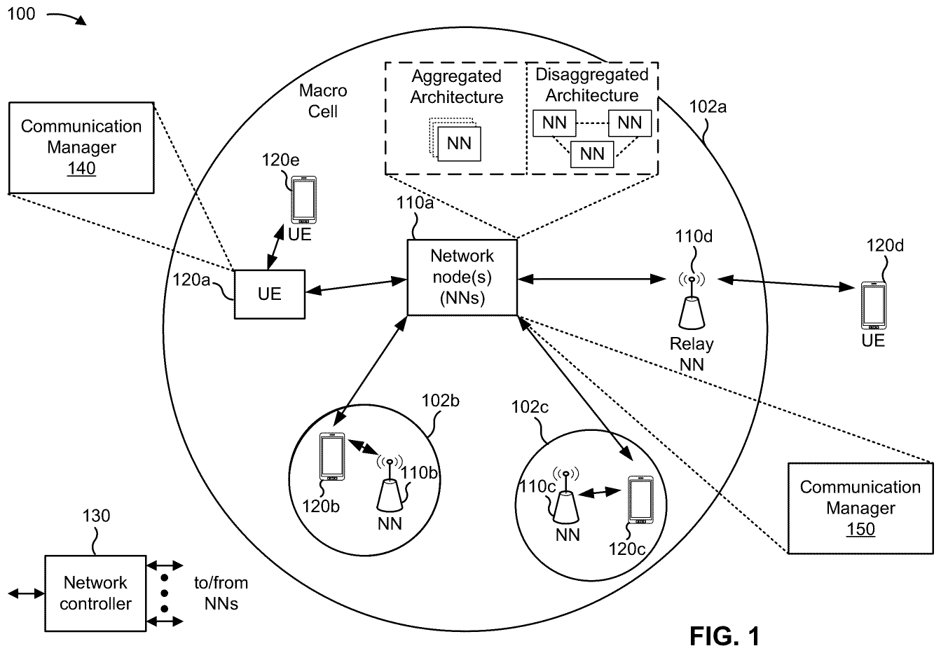

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHZ) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may receive, from a network node, decoder configuration information associated with a transmitter neural network configured to be used to generate at least one latent vector corresponding to one or more computation tasks of a plurality of computation tasks associated with a query-based cross-node machine learning system; receive, from the network node, query configuration information associated with a query-based decoder; and transmit, to the network node and based at least in part on instantiation of the transmitter neural network by the UE, the at least one latent vector. Additionally, or alternatively, the communication manager 140 may perform one or more other operations described herein.

In some aspects, a network node (e.g., the network node 110) may include a communication manager 150. As described in more detail elsewhere herein, the communication manager 150 may transmit, to a UE, decoder configuration information associated with a transmitter neural network configured to be used to generate at least one latent vector corresponding to one or more computation tasks of a plurality of computation tasks associated with a query-based cross-node machine learning system; transmit, to the UE, query configuration information associated with a query-based decoder; and receive, from the UE and based at least in part on instantiation of the transmitter neural network by the UE, the at least one latent vector. Additionally, or alternatively, the communication manager 150 may perform one or more other operations described herein.

As indicated above, FIG. 1 is provided as an example. Other examples may differ from what is described with regard to FIG. 1.

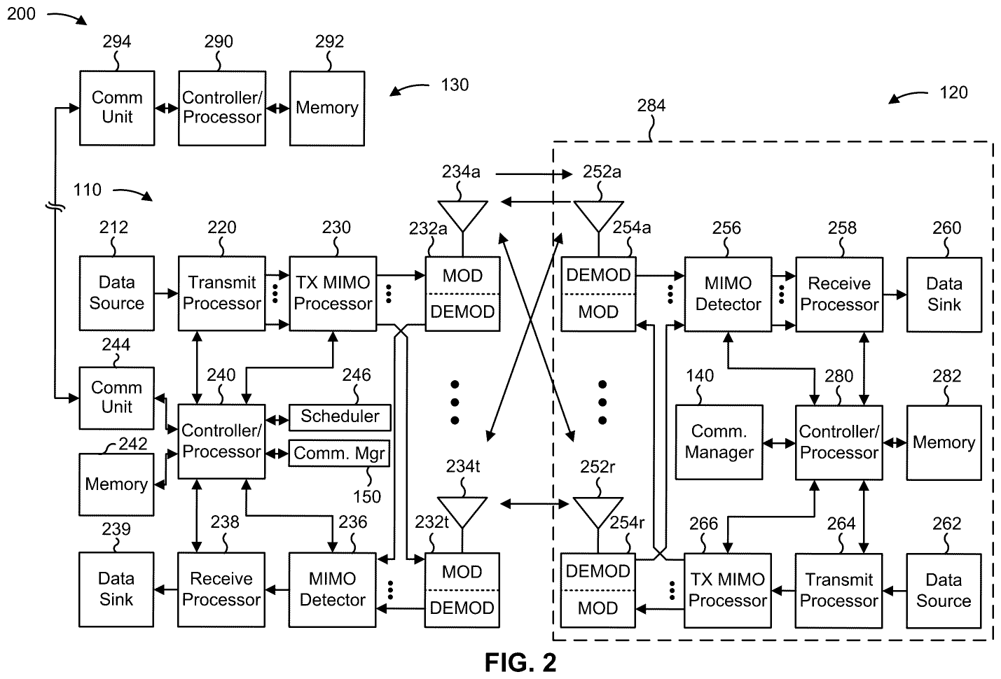

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

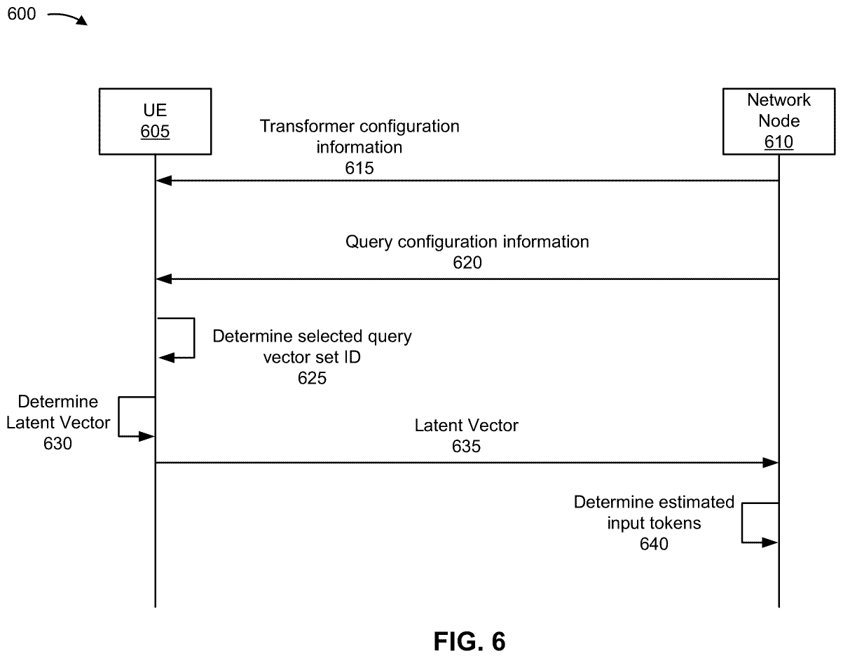

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-12).

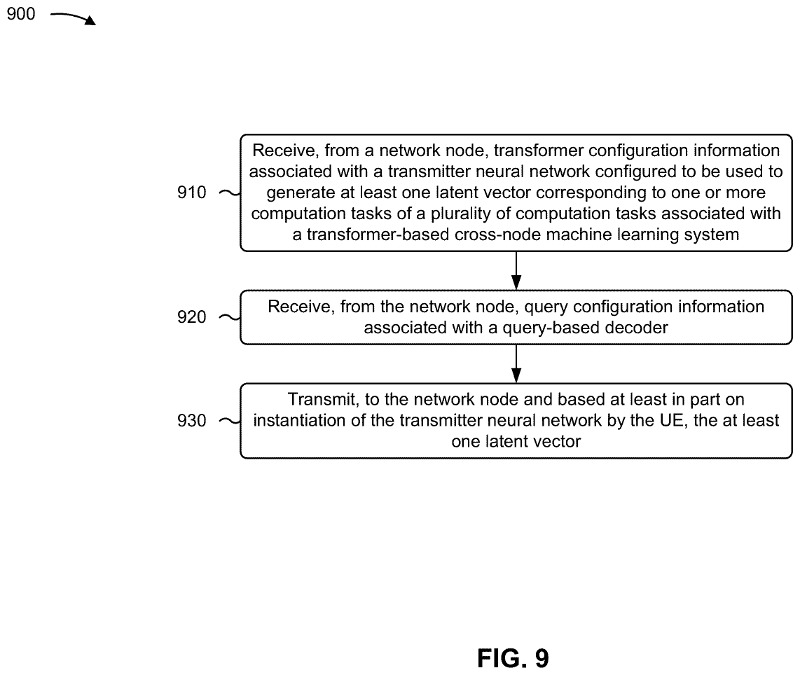

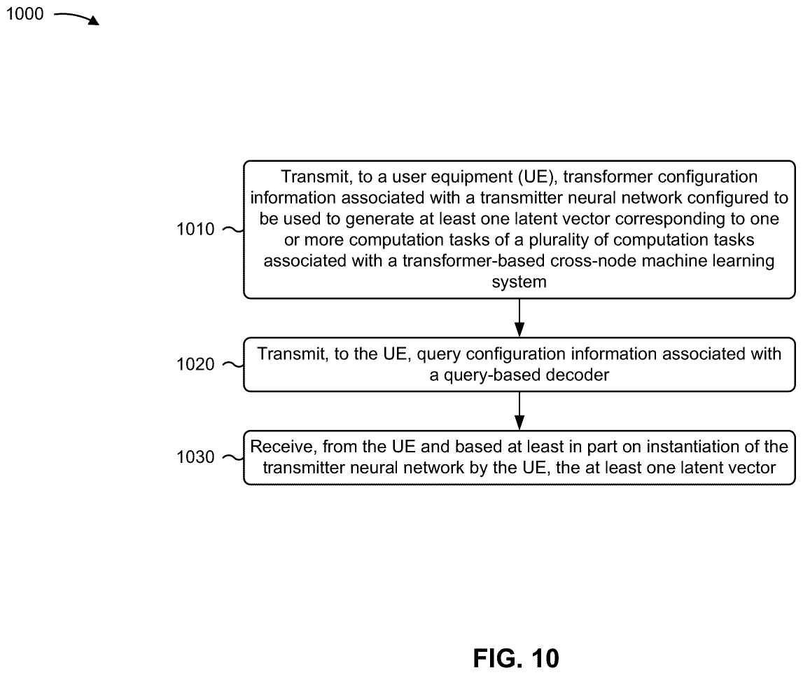

The controller/processor 240 of the network node 110, the controller/processor 280 of the UE 120, and/or any other component(s) of FIG. 2 may perform one or more techniques associated with query-based CSF decoding for cross-node machine learning, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving, from a network node, decoder configuration information associated with a transmitter neural network configured to be used to generate at least one latent vector corresponding to one or more computation tasks of a plurality of computation tasks associated with a query-based cross-node machine learning system; means for receiving, from the network node, query configuration information associated with a query-based decoder; and/or means for transmitting, to the network node and based at least in part on instantiation of the transmitter neural network by the UE, the at least one latent vector. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting, to a UE, decoder configuration information associated with a transmitter neural network configured to be used to generate at least one latent vector corresponding to one or more computation tasks of a plurality of computation tasks associated with a query-based cross-node machine learning system; means for transmitting, to the UE, query configuration information associated with a query-based decoder; and/or means for receiving, from the UE and based at least in part on instantiation of the transmitter neural network by the UE, the at least one latent vector. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

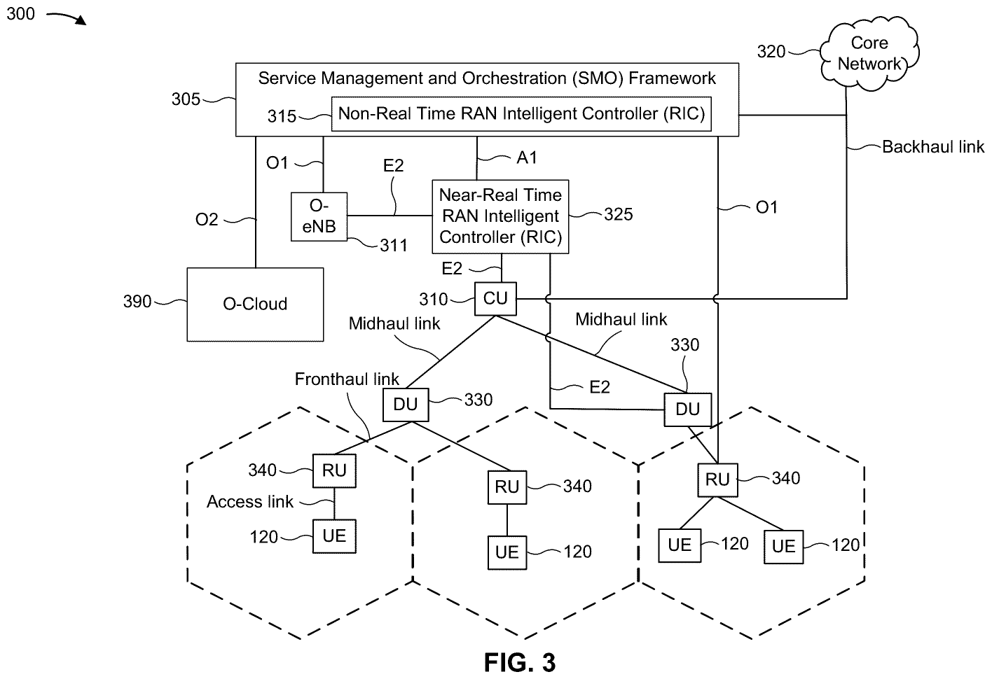

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-ENB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

A UE operating in a wireless network may measure reference signals to report to a network node. For example, the UE may measure reference signals during a beam management process for CSF, may measure received power of reference signals from a serving cell and/or neighbor cells, may measure signal strength of inter-radio access technology (e.g., WiFi) networks, and/or may measure sensor signals for detecting locations of one or more objects within an environment, among other examples. However, reporting this information to the network node may consume communication and/or network resources.

In some aspects described herein, a UE may use one or more neural networks that may be trained to learn dependence of measured qualities on individual parameters, isolate the measured qualities through various layers of the one or more neural networks (also referred to as “operations”), and compress measurements in a way that limits compression loss. The UE may transmit the compressed measurements to the network node. The network node may decode the compressed measurements using one or more decompression operations and reconstruction operations associated with one or more neural networks. The one or more decompression operations and reconstruction operations may be based at least in part on a set of features of the compressed data set to produce reconstructed measurements. The network node may perform a wireless communication action based at least in part on the reconstructed measurements.

In some cases, neural networks may be trained using federated machine learning. Federated machine learning is a machine learning technique that enables multiple client network nodes to collaboratively learn neural network models, while a server does not collect the data from the clients. In a typical case, federated learning techniques involve a single global neural network model trained from the data stored on multiple clients. In some cases, neural networks configured for use in wireless network environments can have functionality that is limited by limitations on network traffic, computational capacity, storage capacity, and/or power capacity, among other examples.

Transformer-based machine learning may become a prevalent architecture in the field of natural language processing (NLP). Transformers use an attention mechanism that enjoys long range connections in comparison to other neural network architectures, such as convolutional neural networks (CNNs) or recurrent neural networks (RNNs). Transformer-based encoders can be used for high-performance image classification tasks. Additionally, end-to-end object detection can be possible using transformer-based machine learning. Accordingly, the application of transformer-based architecture for wireless communications tasks may facilitate more efficient computations and better performance on those tasks.

For example, in some aspects, a transformer-based cross-node machine learning system may include one or more transmitter neural networks (which may be referred to as “TxNNs”) instantiated by one or more UEs and one or more receiver neural networks (which may be referred to as “RxNNs”) instantiated by a network node. In some aspects, a receiver neural network may include a query-based decoder that includes one or more decoder layers. Each decoder layer may use weights and biases that are different from each other decoder layer. In other words, there may be no weight sharing among the decoder layers. However, the same decoder may be used for all the precoding vectors of all MIMO streams. In some aspects, a decoder layer may include a summation component that generates an output comprising a sum of a query embedding from a previous decoder layer and a linear projection of a mapped CSI feedback vector and a multi-layer perceptron (MLP) that performs a post-processing task associated with the output.

Aspects of the techniques described herein may be used for any number of cross-node machine learning challenges including, for example, facilitating CSF, facilitating positioning of a client, and/or learning of modulation and/or waveforms for wireless communication, among other examples. For example, if channel information is used as input to the encoder, the encoder may perform tasks associated with channel state information (CSI) compression and/or reconstruction, environment classification (e.g., indoor environment vs. outdoor environment), first arriving path estimation, line-of-sight (LOS)/non-LOS (NLOS) channel classification, and/or computation of precoders for MIMO transmission ranks, among other examples.

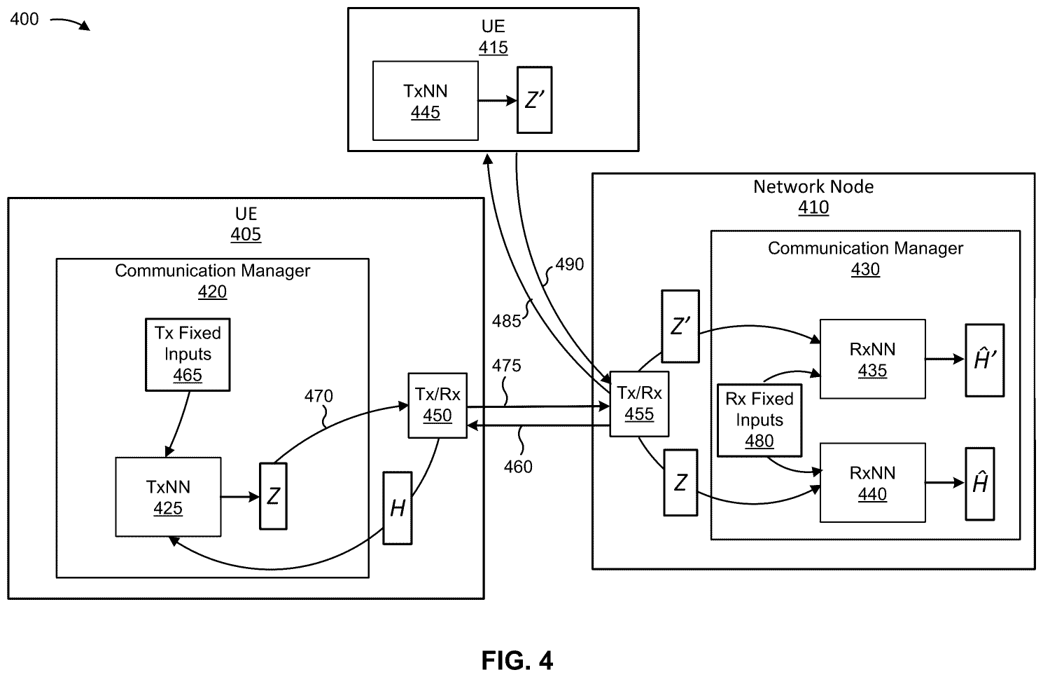

FIG. 4 is a diagram illustrating an example 400 operating environment associated with query-based cross-node machine learning systems for wireless communication, in accordance with the present disclosure. As shown, a UE 405 and a network node 410 may communicate with one another. As shown, an additional UE 415 may communicate with the network node 410 as well. In some aspects, any number of additional UEs not illustrated may be implemented in the context of the operating environment described herein. The UE 405 and/or the UE 415 may be, be similar to, include, or be included in, the UE 120 depicted in FIGS. 1-3. The network node 410 may be, be similar to, include, or be included in, the network node 110 depicted in FIGS. 1 and 2 and/or one or more components of the disaggregated base station architecture 300 depicted in FIG. 3.

As shown, the UE 405 may include a communication manager 420 (e.g., the communication manager 140 shown in FIG. 1) that may be configured to utilize a transmitter neural network 425 to perform one or more computation operations. As shown in FIG. 4, the network node 410 may include a communication manager 430 (e.g., the communication manager 150) that may be configured to utilize one or more receiver neural networks 435 and 440 to perform one or more computation operations. In some aspects, the UE 415 may include a transmitter neural network 445 configured to perform one or more computation operations.

As shown in FIG. 4, the UE 405 may include a transceiver (shown as “Tx/Rx”) 450 that may facilitate wireless communications with a transceiver 455 of the network node 410. As shown by reference number 460, for example, the network node 410 may transmit, using the transceiver 455, a wireless communication to the UE 405. In some aspects, the wireless communication may include a reference signal such as a CSI reference signal (CSI-RS). The transceiver 450 of the UE 405 may receive the wireless communication. The communication manager 420 may determine an input token, H, based at least in part on the wireless communication. The input token H may be a vector. For example, in some aspects, the input token H may include a channel matrix corresponding to a tap of the channel impulse response, a channel matrix corresponding to a subcarrier, and/or a precoding matrix corresponding to a subcarrier, among other examples.

As shown, the communication manager 420 may provide the input token H as input to the transmitter neural network 425. The communication manager 420 also may provide, as inputs, one or more transmitter (Tx) fixed inputs 465. The transmitter neural network 425 may determine a latent vector, Z, based at least in part on the input token H. As shown by reference number 470, the communication manager 420 may provide the latent vector Z to the transceiver 450 for transmission. As shown by reference number 475, the transceiver 450 may transmit, and the transceiver 455 of the network node 410 may receive, the latent vector Z. As shown, the communication manager 430 of the network node 410 may provide the latent vector Z as input to the receiver neural network 440. The communication manager 430 also may provide one or more receiver (Rx) fixed inputs 480 as input to the receiver neural network 440. The receiver neural network 440 may determine (e.g., reconstruct) an estimated input token H based at least in part on the latent vector Z. In some aspects, the network node 410 may perform a wireless communication action based at least in part on the estimated input token A.

As shown by reference number 485, the transceiver 455 of the network node 410 also may transmit a wireless communication signal to the additional UE 415. The additional UE 415 may use the transmitter neural network 445 to determine an additional latent vector, Z′. As shown by reference number 490, the additional UE 415 may transmit, and the transceiver 455 of the network node 410 may receive, the additional latent vector Z′. As shown, the communication manager 430 of the network node 410 may provide the additional latent vector Z′ as input to the receiver neural network 435. The communication manager 430 also may provide one or more Rx fixed inputs 480 as input to the receiver neural network 435. The receiver neural network 435 may determine (e.g., reconstruct) an additional estimated input token λ′ based at least in part on the additional latent vector Z′. In some aspects, the communication manager 430 may utilize the estimated input token H and the additional estimated input token A′ to perform further calculations and/or trigger wireless communication behaviors, among other examples. In some aspects, the combination of the transmitter neural network 425, the transmitter neural network 445, the receiver neural network 435 and the receiver neural network 440 may be referred to as a transformer-based cross-node machine learning system.

As indicated above, FIG. 4 is provided as an example. Other examples may differ from what is described with regard to FIG. 4.

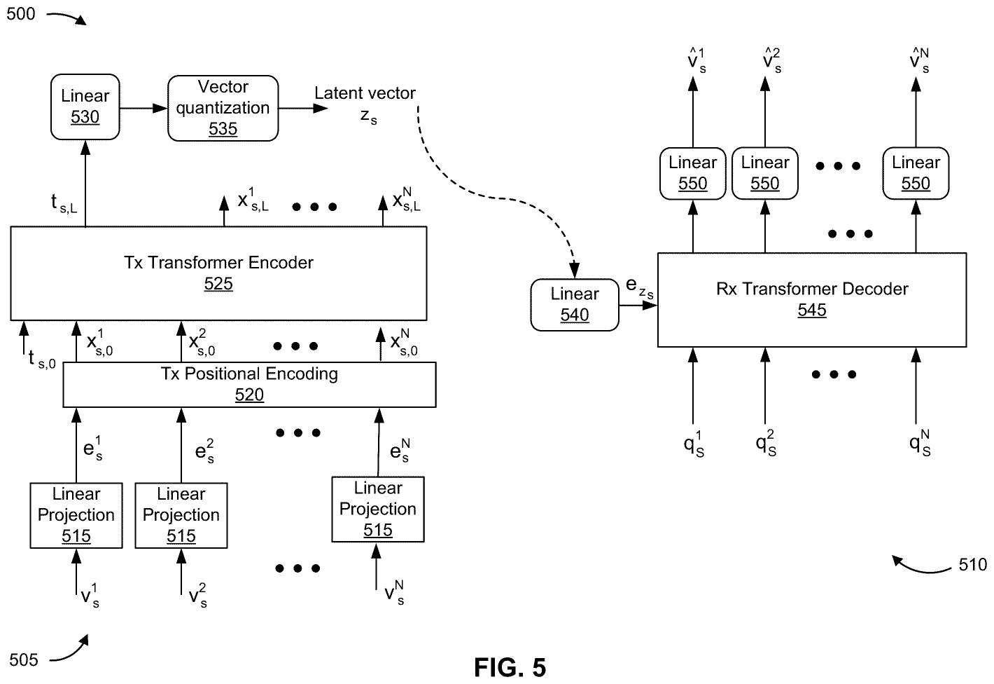

FIG. 5 is a diagram illustrating an example 500 of a query-based cross-node machine learning system, in accordance with the present disclosure. In some aspects, the query-based cross-node machine learning system shown in FIG. 5 may be, be similar to, include, or be included in the query-based cross-node machine learning system described in connection with FIG. 4 above.

As shown in FIG. 5, the query-based cross-node machine learning system may include a transmitter neural network 505 and a receiver neural network 510. The transmitter neural network 505 may be instantiated by a UE (e.g., UE 405 and/or UE 415) and the receiver neural network 510 may be instantiated by a network node (e.g., network node 410). As shown, the transmitter neural network 505 may include a plurality of linear projection components 515 (shown as “Linear Projection”) that take, as input, a set of input token vectors {vₛⁿ}ₙ₌₁^{N}, and generate a set of linear embedding vectors {eₛⁿ}ₙ₌₁^{N} corresponding to the set of input token vectors {vₛⁿ}ₙ₌₁^{N}, respectively. An input token vector is a precoding vector corresponding to a subcarrier. N denotes the number of precoding vectors to compress for each MIMO stream and s is a MIMO stream index (e.g., s=1, 2, 3, or 4 for Rank 4 MIMO). For example, each input token vector vₛⁿ may be mapped to a respective linear embedding vector eₛⁿ.

In some aspects, as shown, the transmitter neural network 505 also may include a transmitter positional encoding component 520 (shown as “Tx Positional Encoding”) that takes, as input, the set of linear embedding vectors {eₛⁿ}ₙ₌₁^{N}. The transmitter positional encoding component 520 may generate a set of embedding vectors {x_{s,0}ⁿ}ₙ₌₁^{N} corresponding to the set of linear embedding vectors {eₛⁿ}ₙ₌₁^{N}. x_{s,l}ⁿ, and eₛⁿ are the D-dimensional embedding vectors for the n-th input token vₛⁿ that represents the n-th precoding vector of the s-th MIMO stream.

As shown, the transmitter neural network 505 also may include a transmitter transformer encoder 525 (shown as “Tx Transformer Encoder”) that takes, as input, the set of embedding vectors {x_{s,0}ⁿ}ₙ₌₁^{N} and a task embedding vector t_{s,0}. t_{s,0} is the D-dimensional task embedding vector for the s-th MIMO stream that is learned during training. Each task embedding vector may correspond to a respective MIMO stream (e.g., t_{s,0} for the s-th MIMO stream). For example, there may be four task embedding vectors for four streams (e.g., in MIMO Rank 4). For example, the input to the Tx Transformer Encoder 525 may include:

$${x}_{s , 0} = [ {t}_{s , 0} ; {v}_{s}^{1} E ; {v}_{s}^{2} E ; … ; {v}_{s}^{N} E ] + {E}_{pos , s} ,$$

where t_{s,0} is a learnable embedding vector (which may be referred to as a task token), vₛⁿ is the n-th input token vector (n=1, 2, . . . , N), E is a trainable linear projection matrix common to all the input tokens, eₛⁿ=vₛⁿE is a linear embedding of vₛⁿ, and E_{pos,s} is a (N+1)× D position embedding matrix that may be learned, which is used for the s-th MIMO stream.

The transmitter transformer encoder 525 may generate a set of transformed embedding vectors {x_{s,L}ⁿ}ₙ₌₁^{N} corresponding to the set of embedding vectors {x_{s,0}ⁿ}ₙ₌₁^{N} and an output embedding vector t_{s,L} corresponding to the task token t_{s,0}. The transmitter transformer encoder 525 may include at least one transformer encoder layer. For example, the output of the l-th Transformer encoder layer may include a matrix of token embeddings denoted by x_{s,l}=[t_{s,l}; x_{s,l}¹; . . . ; x_{s,l}^{N}], where x_{s,l} (l=1, 2, . . . , L) denotes a set of token embeddings at the output of the l-th transformer encoder layer in the transformer encoder, x_{s,0} denotes a set of token embeddings at the input to the transformer encoder, x_{s,L} denotes a set of token embeddings at the output of the transformer encoder, and t_{s,l} denotes the task embedding vector at the output of the l-th transformer encoder layer in the transformer encoder.

The output embedding vector t_{s,L} may be provided as input to a linear layer 530 (shown as “Linear”), which computes the lower dimensional latent vector that represents the summary of the precoding vectors {vₛⁿ; n=1, 2, . . . , N}. The output of the linear layer 530 is quantized to the latent vector zₛ using a vector quantization component 535. The latent vector zₛ is then reported to the receiving node (e.g., the network node). Thus, the latent vector zₛ is the CSI feedback for the s-th MIMO stream.

As shown in FIG. 5, the receiver neural network 510 may include a linear layer 540 that maps the latent vector zₛ to a mapped embedding vector e_{z}_{ₛ}. The receiver neural network 510 also includes a receiver transformer decoder 545 (shown as “Rx Transformer Decoder”) that takes, as input, the mapped embedding vector e_{z}_{ₛ} and a set of D-dimensional learned embedding vectors for the s-th MIMO stream as precoding vector queries. For example, the set of D-dimensional learned embedding vectors may include a set of N query vectors: {qₛ¹, qₛ², . . . , qₛ^{N}}, with the query qₛⁿ for the n-th precoding vector vₛⁿ for the s-th MIMO stream. The output of the Rx Transformer Decoder 545 is processed through linear components 550 to produce estimated input token vectors \hat{v}ₛ¹, \hat{v}ₛ², . . . , \hat{v}ₛ^{N}. The key and value for the cross attention are computed from the linear layer output e_{z}_{ₛ} in response to the CSI feedback vector zₛ received from the transmitting node 505. The self-attention layers in the receiver transformer decoder 545 have the quadratic computational complexity with respect to the number of input vectors N, which makes the decoding slow for very large N. Thus, the complexity due to self-attention scales quadratically with respect to the number of input vectors. It can be more prohibitive for implementation at network nodes, since the network node has to perform CSI feedback decompression for multiple UEs at the same time.

Some aspects of the techniques and apparatuses described herein may include query-based CSF decoding for cross-node machine learning. For example, in some aspects, an alternative neural network architecture (e.g., the query-based decoder) may be provided for implementing a CSF decoder. In some aspects, the query-based decoder may perform decoding with a similar accuracy as a transformer decoder, but with a reduction in complexity as compared to that of a transformer decoder. Some aspects include signaling that allows the network and the UE to select a decoder and query vectors to optimize a performance for the deployment.

For example, in some aspects, a UE may receive decoder configuration information associated with a transmitter neural network configured to be used to generate at least one latent vector corresponding to one or more computation tasks of a plurality of computation tasks associated with a query-based cross-node machine learning system. The UE may further receive query configuration information associated with a query-based decoder. The UE may transmit, based at least in part on instantiation of the transmitter neural network by the UE, the at least one latent vector.

As indicated above, FIG. 5 is provided as an example. Other examples may differ from what is described with regard to FIG. 5.

FIG. 6 is a diagram illustrating an example 600 of a call flow associated with query-based CSF decoding for cross-node machine learning systems for wireless communication, in accordance with the present disclosure. As shown, a UE 605 and a network node 610 may communicate with one another. The UE 605 may be, be similar to, include, or be included in, the UE 405 and/or the UE 415 depicted in FIG. 4. The network node 610 may be, be similar to, include, or be included in, the network node 410 depicted in FIG. 4.

As shown by reference number 615, the network node 610 may transmit, and the UE 605 may receive, decoder configuration information. In some aspects, the network node 610 may transmit the decoder configuration information by transmitting an upper-layer communication including the decoder configuration information. In some aspects, the upper-layer communication may include an RRC message. In some aspects, the decoder configuration information may include a system information block (SIB). In some aspects, the decoder configuration information may be associated with a transmitter neural network configured to be used to generate at least one latent vector corresponding to one or more computation tasks of a plurality of computation tasks associated with a query-based cross-node machine learning system.

In some aspects, the decoder configuration information may include a transmitter neural network (e.g., the transmitter neural network 505 depicted in FIG. 5) configured to be used to generate at least one latent vector corresponding to one or more computation tasks of a plurality of computation tasks associated with a query-based cross-node machine learning system. In some aspects, for example, the query-based cross-node machine learning system may include the transmitter neural network instantiated by the UE 605 and a plurality of receiver neural networks instantiated by the network node 610. Each receiver neural network of the plurality of receiver neural networks may correspond to a computation task of the plurality of computation tasks. In some aspects, the transformer configuration may indicate at least one of a set of transmitter transformer encoder parameters, a position embedding matrix, a linear projection matrix, a set of task embedding vectors, and/or an indication of an ordering of the set of task embedding vectors and a set of linear token embeddings.

As shown by reference number 620, the network node 610 may transmit, and the UE 605 may receive, query configuration information. In some aspects, the query configuration information may indicate at least one reference decoder structure associated with a query-based decoder. The at least one reference decoder structure may include a reference decoder associated with a respective complexity metric of a plurality of complexity metrics. The plurality of complexity metrics may indicate at least one of a quantity of layers or an embedding dimension. In some aspects, the query configuration information may include at least one reference decoder identifier (ID) associated with the at least one reference decoder structure. A reference decoder structure of the at least one reference decoder structure may be associated with a plurality of sets of query vectors. In some aspects, the query configuration information may indicate at least one query vector associated with the query-based decoder. The at least one query vector may include a plurality of query vector sets associated with a reference decoder ID, and each query vector set of the plurality of query vector sets may be associated with a respective query vector set ID of a plurality of query vector set IDs.

As shown by reference number 625, the UE 605 may determine a selected query vector set ID. For example, in some aspects, the query configuration information may indicate a selected query vector set ID of the plurality of query vector set IDs. In some aspects, the UE 605 may determine a selected query vector set ID and report the selected query vector set ID to the network node 610 via upper-layer signaling. In this way, the UE 605 may find the best performing query vector set given the reference decoder selected by the network node 610. Since the reference decoder is low complexity, the UE 605 may try different choices of query vector set IDs.

In some aspects, the at least one query vector comprises a set of query vectors associated with at least one of a subband granularity of a plurality of subband granularities, a bandwidth part (BWP) of a plurality of BWPs, or a reference decoder ID of a plurality of reference decoder IDs. In some aspects, the transmitter neural network may include an encoder, of a plurality of encoders, associated with the subband granularity, the BWP, and the reference decoder ID. In some aspects, the at least one query vector may include a query vector associated with at least one respective precoding vector of a plurality of precoding vectors associated with a MIMO stream. In some aspects, the at least one query vector may include a plurality of query vectors associated with the MIMO stream.

As shown by reference number 630, the UE 605 may determine a latent vector. In some aspects, for example, the UE 605 may determine the latent vector as described herein. As shown by reference number 635, the UE 605 may transmit, and the network node 610 may receive, the latent vector. As shown by reference number 640, the network node 610 may determine a set of estimated input tokens based at least in part on the latent vector.

As indicated above, FIG. 6 is provided as an example. Other examples may differ from what is described with regard to FIG. 6.

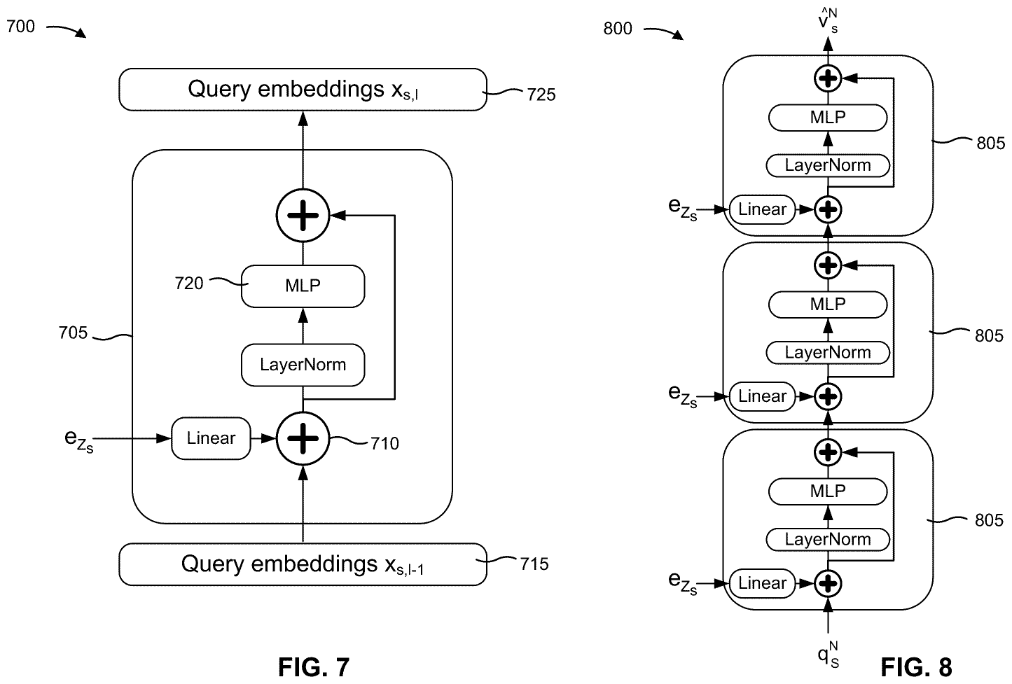

FIG. 7 is a diagram illustrating an example 700 of a query-based decoder layer 705, in accordance with the present disclosure. As shown, the query-based decoder may include at least one decoder layer 705 including a summation component 710 that generates an output comprising a sum of a query embedding 715 from a previous decoder layer and a linear projection of a mapped CSI feedback vector e_{z}_{ₛ}; and an MLP 720 that performs a post-processing task associated with a normalized (e.g., via a normalization layer shown as “LayerNorm”) output of the summation component 710.

In some aspects, for example, x_{s,l}ⁿ (l=1, 2, . . . , L) denotes a query embedding 725 at the output of the l-th decoder layer for the n-th precoding vector of the s-th MIMO stream, and x_{s,l} is a N×D matrix given by x_{s,l}=[x_{s,l}¹; x_{s,l}²; . . . ; x_{s,l}^{N}]. The N×D matrix may be denoted

$${x}_{s , l} = M L {P}_{l} ( L {N}_{l} ( {y}_{s , l} ) ) + {y}_{s , l} ,$$

where LN=Layer normalization, the MLP includes two linear layers with a non-linear activation (e.g., a Gaussian Error Linear Unit (GELU) non-linearity) in between the two, y_{s,l}=1_{N×1}·e_{z}_{ₛ}Wₗ+x_{s,l-1}, where Wₗ denotes the D×D Linear projection matrix for the l-th decoder layer, and x_{s,0}ⁿ denotes the learned query embedding at the input to the decoder for the n-th precoding vector of the s-th MIMO stream, i.e. x_{s,0}ⁿ=qₛⁿ. In some aspects, each decoder layer may include two steps: sum the query embedding from the previous decoder layer with linear projection of 1×D CSF vector e_{z}_{ₛ} and post-process the result using an MLP.

As indicated above, FIG. 7 is provided as an example. Other examples may differ from what is described with regard to FIG. 7.

FIG. 8 is a diagram illustrating an example 800 of a decoder structure, in accordance with the present disclosure. The illustrated decoder structure may include three decoder layers 805. Each decoder layer 805 may be, be similar to, include, or be included in, the decoder layer 705 depicted in FIG. 7. Each decoder layer may use weights and biases that are different from the other decoder layer. In some aspects, there may be no weight sharing among the decoder layers. FIG. 8 illustrates that the decoder produces the estimated input token vector \hat{v}ₛ^{N} in response to the query qₛ^{N}. Similarly, for the estimated input token vector \hat{v}ₛ^{N}, the query qₛⁿ may be provided as input to the same decoder.

As indicated above, FIG. 8 is provided as an example. Other examples may differ from what is described with regard to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 605) performs operations associated with query-based CSF decoding for cross-node machine learning.

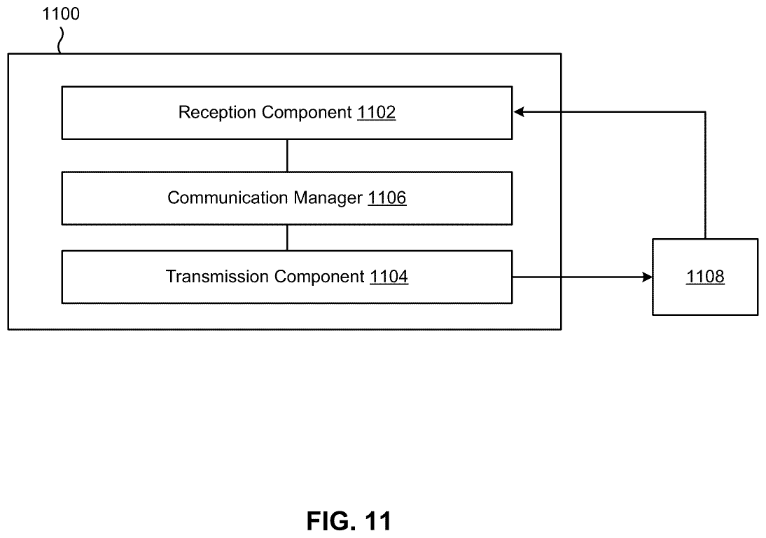

As shown in FIG. 9, in some aspects, process 900 may include receiving, from a network node, decoder configuration information associated with a transmitter neural network configured to be used to generate at least one latent vector corresponding to one or more computation tasks of a plurality of computation tasks associated with a query-based cross-node machine learning system (block 910). For example, the UE (e.g., using reception component 1102 and/or communication manager 1106, depicted in FIG. 11) may receive, from a network node, decoder configuration information associated with a transmitter neural network configured to be used to generate at least one latent vector corresponding to one or more computation tasks of a plurality of computation tasks associated with a query-based cross-node machine learning system, as described above.

As further shown in FIG. 9, in some aspects, process 900 may include receiving, from the network node, query configuration information associated with a query-based decoder (block 920). For example, the UE (e.g., using reception component 1102 and/or communication manager 1106, depicted in FIG. 11) may receive, from the network node, query configuration information associated with a query-based decoder, as described above.

As further shown in FIG. 9, in some aspects, process 900 may include transmitting, to the network node and based at least in part on instantiation of the transmitter neural network by the UE, the at least one latent vector (block 930). For example, the UE (e.g., using transmission component 1104 and/or communication manager 1106, depicted in FIG. 11) may transmit, to the network node and based at least in part on instantiation of the transmitter neural network by the UE, the at least one latent vector, as described above.

Process 900 may include additional aspects, such as any single aspect or any combination of aspects described below and/or in connection with one or more other processes described elsewhere herein.

In a first aspect, the query configuration information indicates at least one reference decoder structure associated with the query-based decoder.

In a second aspect, alone or in combination with the first aspect, the at least one reference decoder structure comprises a reference decoder associated with a respective complexity metric of a plurality of complexity metrics.

In a third aspect, alone or in combination with one or more of the first and second aspects, the plurality of complexity metrics indicates at least one of a quantity of layers or an embedding dimension.

In a fourth aspect, alone or in combination with one or more of the first through third aspects, the query configuration information comprises at least one reference decoder ID associated with the at least one reference decoder structure.

In a fifth aspect, alone or in combination with one or more of the first through fourth aspects, a reference decoder structure of the at least one reference decoder structure is associated with a plurality of sets of query vectors.

In a sixth aspect, alone or in combination with one or more of the first through fifth aspects, receiving the query configuration information comprises receiving at least one of a radio resource control message or a system information block.

In a seventh aspect, alone or in combination with one or more of the first through sixth aspects, the query configuration information indicates at least one query vector associated with the query-based decoder.

In an eighth aspect, alone or in combination with one or more of the first through seventh aspects, the at least one query vector comprises a plurality of query vector sets associated with a reference decoder ID, and each query vector set of the plurality of query vector sets is associated with a respective query vector set ID of a plurality of query vector set IDs.

In a ninth aspect, alone or in combination with one or more of the first through eighth aspects, the query configuration information indicates a selected query vector set ID of the plurality of query vector set IDs.

In a tenth aspect, alone or in combination with one or more of the first through ninth aspects, process 900 includes transmitting, to the network node, an indication of a selected query vector set ID of the plurality of query vector set IDs.

In an eleventh aspect, alone or in combination with one or more of the first through tenth aspects, the at least one query vector comprises a set of query vectors associated with at least one of a subband granularity of a plurality of subband granularities, a BWP of a plurality of BWPs, or a reference decoder ID of a plurality of reference decoder IDs.

In a twelfth aspect, alone or in combination with one or more of the first through eleventh aspects, the transmitter neural network comprises an encoder, of a plurality of encoders, associated with the subband granularity, the BWP, and the reference decoder ID.

In a thirteenth aspect, alone or in combination with one or more of the first through twelfth aspects, the at least one query vector comprises a query vector associated with at least one respective precoding vector of a plurality of precoding vectors associated with a MIMO stream.

In a fourteenth aspect, alone or in combination with one or more of the first through thirteenth aspects, the at least one query vector comprises a plurality of query vectors associated with the MIMO stream.

In a fifteenth aspect, alone or in combination with one or more of the first through fourteenth aspects, the query-based decoder comprises at least one decoder layer including a summation component that generates an output comprising a sum of a query embedding from a previous decoder layer and a linear projection of a mapped CSI feedback vector, and a multi-layer perceptron that performs a post-processing task associated with the output.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 610) performs operations associated with query-based CSF decoding for cross-node machine learning.

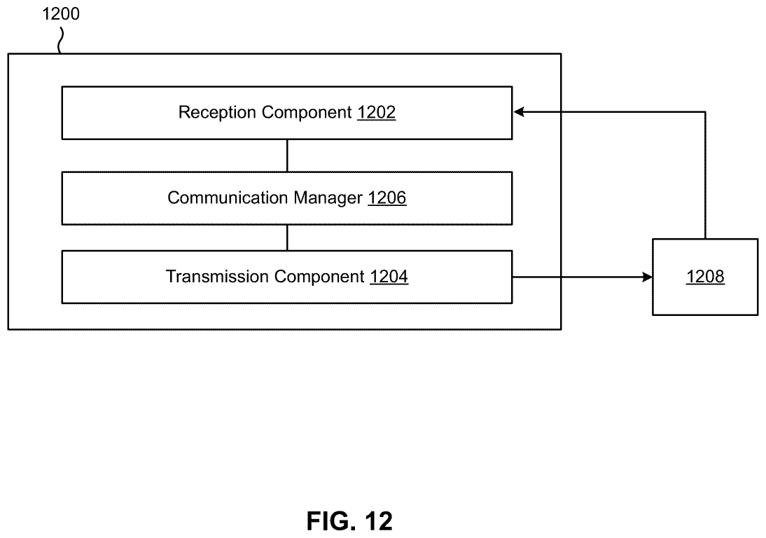

As shown in FIG. 10, in some aspects, process 1000 may include transmitting, to a UE, decoder configuration information associated with a transmitter neural network configured to be used to generate at least one latent vector corresponding to one or more computation tasks of a plurality of computation tasks associated with a query-based cross-node machine learning system (block 1010). For example, the network node (e.g., using transmission component 1204 and/or communication manager 1206, depicted in FIG. 12) may transmit, to a UE, decoder configuration information associated with a transmitter neural network configured to be used to generate at least one latent vector corresponding to one or more computation tasks of a plurality of computation tasks associated with a query-based cross-node machine learning system, as described above.

As further shown in FIG. 10, in some aspects, process 1000 may include transmitting, to the UE, query configuration information associated with a query-based decoder (block 1020). For example, the network node (e.g., using transmission component 1204 and/or communication manager 1206, depicted in FIG. 12) may transmit, to the UE, query configuration information associated with a query-based decoder, as described above.

As further shown in FIG. 10, in some aspects, process 1000 may include receiving, from the UE and based at least in part on instantiation of the transmitter neural network by the UE, the at least one latent vector (block 1030). For example, the network node (e.g., using reception component 1202 and/or communication manager 1206, depicted in FIG. 12) may receive, from the UE and based at least in part on instantiation of the transmitter neural network by the UE, the at least one latent vector, as described above.

Process 1000 may include additional aspects, such as any single aspect or any combination of aspects described below and/or in connection with one or more other processes described elsewhere herein.

In a first aspect, the query configuration information indicates at least one reference decoder structure associated with the query-based decoder.

In a second aspect, alone or in combination with the first aspect, the at least one reference decoder structure comprises a reference decoder associated with a respective complexity metric of a plurality of complexity metrics.

In a third aspect, alone or in combination with one or more of the first and second aspects, the plurality of complexity metrics indicates at least one of a quantity of layers or an embedding dimension.

In a fourth aspect, alone or in combination with one or more of the first through third aspects, the query configuration information comprises at least one reference decoder ID associated with the at least one reference decoder structure.

In a fifth aspect, alone or in combination with one or more of the first through fourth aspects, a reference decoder structure of the at least one reference decoder structure is associated with a plurality of sets of query vectors.

In a sixth aspect, alone or in combination with one or more of the first through fifth aspects, transmitting the query configuration information comprises transmitting at least one of a radio resource control message or a system information block.

In a seventh aspect, alone or in combination with one or more of the first through sixth aspects, the query configuration information indicates at least one query vector associated with the query-based decoder.

In an eighth aspect, alone or in combination with one or more of the first through seventh aspects, the at least one query vector comprises a plurality of query vector sets associated with a reference decoder ID, and each query vector set of the plurality of query vector sets is associated with a respective query vector set ID of a plurality of query vector set IDs.

In a ninth aspect, alone or in combination with one or more of the first through eighth aspects, the query configuration information indicates a selected query vector set ID of the plurality of query vector set IDs.

In a tenth aspect, alone or in combination with one or more of the first through ninth aspects, process 1000 includes receiving, from the UE, an indication of a selected query vector set ID of the plurality of query vector set IDs.

In an eleventh aspect, alone or in combination with one or more of the first through tenth aspects, the at least one query vector comprises a set of query vectors associated with at least one of a subband granularity of a plurality of subband granularities, a BWP of a plurality of BWPs, or a reference decoder ID of a plurality of reference decoder IDs.

In a twelfth aspect, alone or in combination with one or more of the first through eleventh aspects, the transmitter neural network comprises an encoder, of a plurality of encoders, associated with the subband granularity, the BWP, and the reference decoder ID.

In a thirteenth aspect, alone or in combination with one or more of the first through twelfth aspects, the at least one query vector comprises a query vector associated with at least one respective precoding vector of a plurality of precoding vectors associated with a MIMO stream.

In a fourteenth aspect, alone or in combination with one or more of the first through thirteenth aspects, the at least one query vector comprises a plurality of query vectors associated with the MIMO stream.

In a fifteenth aspect, alone or in combination with one or more of the first through fourteenth aspects, the query-based decoder comprises at least one decoder layer including a summation component that generates an output comprising a sum of a query embedding from a previous decoder layer and a linear projection of a mapped CSI feedback vector, and a multi-layer perceptron that performs a post-processing task associated with the output.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 6-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive, from a network node, decoder configuration information associated with a transmitter neural network configured to be used to generate at least one latent vector corresponding to one or more computation tasks of a plurality of computation tasks associated with a query-based cross-node machine learning system. The reception component 1102 may receive, from the network node, query configuration information associated with a query-based decoder. The transmission component 1104 may transmit, to the network node and based at least in part on instantiation of the transmitter neural network by the UE, the at least one latent vector.

The transmission component 1104 may transmit, to the network node, an indication of a selected query vector set ID of the plurality of query vector set IDs.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 6-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit, to a UE, decoder configuration information associated with a transmitter neural network configured to be used to generate at least one latent vector corresponding to one or more computation tasks of a plurality of computation tasks associated with a query-based cross-node machine learning system. The transmission component 1204 may transmit, to the UE, query configuration information associated with a query-based decoder. The reception component 1202 may receive, from the UE and based at least in part on instantiation of the transmitter neural network by the UE, the at least one latent vector.

The reception component 1202 may receive, from the UE, an indication of a selected query vector set ID of the plurality of query vector set IDs.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving, from a network node, decoder configuration information associated with a transmitter neural network configured to be used to generate at least one latent vector corresponding to one or more computation tasks of a plurality of computation tasks associated with a query-based cross-node machine learning system; receiving, from the network node, query configuration information associated with a query-based decoder; and transmitting, to the network node and based at least in part on instantiation of the transmitter neural network by the UE, the at least one latent vector.

Aspect 2: The method of Aspect 1, wherein the query configuration information indicates at least one reference decoder structure associated with the query-based decoder.

Aspect 3: The method of Aspect 2, wherein the at least one reference decoder structure comprises a reference decoder associated with a respective complexity metric of a plurality of complexity metrics.

Aspect 4: The method of Aspect 3, wherein the plurality of complexity metrics indicates at least one of a quantity of layers or an embedding dimension.

Aspect 5: The method of any of Aspects 2-4, wherein the query configuration information comprises at least one reference decoder identifier (ID) associated with the at least one reference decoder structure.

Aspect 6: The method of any of Aspects 2-5, wherein a reference decoder structure of the at least one reference decoder structure is associated with a plurality of sets of query vectors.

Aspect 7: The method of any of Aspects 1-6, wherein receiving the query configuration information comprises receiving at least one of a radio resource control message or a system information block.

Aspect 8: The method of any of Aspects 1-7, wherein the query configuration information indicates at least one query vector associated with the query-based decoder.

Aspect 9: The method of Aspect 8, wherein the at least one query vector comprises a plurality of query vector sets associated with a reference decoder identifier (ID), and wherein each query vector set of the plurality of query vector sets is associated with a respective query vector set ID of a plurality of query vector set IDs.

Aspect 10: The method of Aspect 9, wherein the query configuration information indicates a selected query vector set ID of the plurality of query vector set IDs.

Aspect 11: The method of either of Aspects 9 or 10, further comprising transmitting, to the network node, an indication of a selected query vector set ID of the plurality of query vector set IDs.

Aspect 12: The method of any of Aspects 8-11, wherein the at least one query vector comprises a set of query vectors associated with at least one of a subband granularity of a plurality of subband granularities, a bandwidth part (BWP) of a plurality of BWPs, or a reference decoder identifier (ID) of a plurality of reference decoder IDs.

Aspect 13: The method of Aspect 12, wherein the transmitter neural network comprises an encoder, of a plurality of encoders, associated with the subband granularity, the BWP, and the reference decoder ID.

Aspect 14: The method of any of Aspects 8-13, wherein the at least one query vector comprises a query vector associated with at least one respective precoding vector of a plurality of precoding vectors associated with a multiple input multiple output (MIMO) stream.

Aspect 15: The method of Aspect 14, wherein the at least one query vector comprises a plurality of query vectors associated with the MIMO stream.

Aspect 16: The method of any of Aspects 1-15, wherein the query-based decoder comprises at least one decoder layer including: a summation component that generates an output comprising a sum of a query embedding from a previous decoder layer and a linear projection of a mapped channel state information feedback vector; and a multi-layer perceptron that performs a post-processing task associated with the output.

Aspect 17: A method of wireless communication performed by a network node, comprising: transmitting, to a user equipment (UE), decoder configuration information associated with a transmitter neural network configured to be used to generate at least one latent vector corresponding to one or more computation tasks of a plurality of computation tasks associated with a query-based cross-node machine learning system; transmitting, to the UE, query configuration information associated with a query-based decoder; and receiving, from the UE and based at least in part on instantiation of the transmitter neural network by the UE, the at least one latent vector.

Aspect 18: The method of Aspect 17, wherein the query configuration information indicates at least one reference decoder structure associated with the query-based decoder.

Aspect 19: The method of Aspect 18, wherein the at least one reference decoder structure comprises a reference decoder associated with a respective complexity metric of a plurality of complexity metrics.

Aspect 20: The method of Aspect 19, wherein the plurality of complexity metrics indicates at least one of a quantity of layers or an embedding dimension.

Aspect 21: The method of any of Aspects 18-20, wherein the query configuration information comprises at least one reference decoder identifier (ID) associated with the at least one reference decoder structure.

Aspect 22: The method of any of Aspects 18-21, wherein a reference decoder structure of the at least one reference decoder structure is associated with a plurality of sets of query vectors.

Aspect 23: The method of any of Aspects 17-22, wherein transmitting the query configuration information comprises transmitting at least one of a radio resource control message or a system information block.

Aspect 24: The method of any of Aspects 17-23, wherein the query configuration information indicates at least one query vector associated with the query-based decoder.

Aspect 25: The method of Aspect 24, wherein the at least one query vector comprises a plurality of query vector sets associated with a reference decoder identifier (ID), and wherein each query vector set of the plurality of query vector sets is associated with a respective query vector set ID of a plurality of query vector set IDs.

Aspect 26: The method of Aspect 25, wherein the query configuration information indicates a selected query vector set ID of the plurality of query vector set IDs.

Aspect 27: The method of either of Aspects 25 or 26, further comprising receiving, from the UE, an indication of a selected query vector set ID of the plurality of query vector set IDs.

Aspect 28: The method of any of Aspects 24-27, wherein the at least one query vector comprises a set of query vectors associated with at least one of a subband granularity of a plurality of subband granularities, a bandwidth part (BWP) of a plurality of BWPs, or a reference decoder identifier (ID) of a plurality of reference decoder IDs.

Aspect 29: The method of Aspect 28, wherein the transmitter neural network comprises an encoder, of a plurality of encoders, associated with the subband granularity, the BWP, and the reference decoder ID.

Aspect 30: The method of any of Aspects 24-29, wherein the at least one query vector comprises a query vector associated with at least one respective precoding vector of a plurality of precoding vectors associated with a multiple input multiple output (MIMO) stream.

Aspect 31: The method of Aspect 30, wherein the at least one query vector comprises a plurality of query vectors associated with the MIMO stream.

Aspect 32: The method of any of Aspects 17-31, wherein the query-based decoder comprises at least one decoder layer including: a summation component that generates an output comprising a sum of a query embedding from a previous decoder layer and a linear projection of a mapped channel state information feedback vector; and a multi-layer perceptron that performs a post-processing task associated with the output.

Aspect 33: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-16.

Aspect 34: An apparatus for wireless communication at a device, the apparatus comprising one or more memories and one or more processors coupled to the one or more memories, the one or more processors configured to cause the device to perform the method of one or more of Aspects 1-16.

Aspect 35: An apparatus for wireless communication, the apparatus comprising at least one means for performing the method of one or more of Aspects 1-16.

Aspect 36: A non-transitory computer-readable medium storing code for wireless communication, the code comprising instructions executable by one or more processors to perform the method of one or more of Aspects 1-16.

Aspect 37: A non-transitory computer-readable medium storing a set of instructions for wireless communication, the set of instructions comprising one or more instructions that, when executed by one or more processors of a device, cause the device to perform the method of one or more of Aspects 1-16.

Aspect 38: A device for wireless communication, the device comprising a processing system that includes one or more processors and one or more memories coupled with the one or more processors, the processing system configured to cause the device to perform the method of one or more of Aspects 1-16.

Aspect 39: An apparatus for wireless communication at a device, the apparatus comprising one or more memories and one or more processors coupled to the one or more memories, the one or more processors individually or collectively configured to cause the device to perform the method of one or more of Aspects 1-16.

Aspect 40: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 17-32.

Aspect 41: An apparatus for wireless communication at a device, the apparatus comprising one or more memories and one or more processors coupled to the one or more memories, the one or more processors configured to cause the device to perform the method of one or more of Aspects 17-32.

Aspect 42: An apparatus for wireless communication, the apparatus comprising at least one means for performing the method of one or more of Aspects 17-32.

Aspect 43: A non-transitory computer-readable medium storing code for wireless communication, the code comprising instructions executable by one or more processors to perform the method of one or more of Aspects 17-32.

Aspect 44: A non-transitory computer-readable medium storing a set of instructions for wireless communication, the set of instructions comprising one or more instructions that, when executed by one or more processors of a device, cause the device to perform the method of one or more of Aspects 17-32.

Aspect 45: A device for wireless communication, the device comprising a processing system that includes one or more processors and one or more memories coupled with the one or more processors, the processing system configured to cause the device to perform the method of one or more of Aspects 17-32.

Aspect 39: An apparatus for wireless communication at a device, the apparatus comprising one or more memories and one or more processors coupled to the one or more memories, the one or more processors individually or collectively configured to cause the device to perform the method of one or more of Aspects 17-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
one or more memories; and
one or more processors, coupled to the one or more memories, which, individually or in any combination, are operable to cause the apparatus to:
receive a transformer configuration that includes a transmitter neural network configured to be used to generate at least one latent vector corresponding to one or more channel state information (CSI) feedback tasks of a plurality of CSI feedback tasks associated with a transformer-based cross-node machine learning system; and
transmit the at least one latent vector based at least in part on instantiating the transmitter neural network.

2. The apparatus of claim 1, wherein the transmitter neural network includes a transmitter positional encoding component that takes, as input, a set of linear embedding vectors.

3. The apparatus of claim 2, wherein the transmitter positional encoding component generates a set of embedding vectors corresponding to the set of linear embedding vectors.

4. The apparatus of claim 3, wherein the transmitter neural network includes a transmitter transformer encoder that takes, as input, a task embedding vector, of the set of embedding vectors, wherein the task embedding vector is an embedding vector for a multiple input multiple output (MIMO) stream.

5. The apparatus of claim 2, wherein the transformer configuration indicates at least one of:
the set of linear embedding vectors, or
an indication of an ordering of a set of task embedding vectors and the set of linear token embeddings.

6. The apparatus of claim 2, wherein the transmitter neural network includes a transmitter transformer encoder that takes, as input, the set of embedding vectors.

7. The apparatus of claim 1, wherein the transformer configuration indicates at least one of:
a set of transmitter transformer encoder parameters,
a position embedding matrix, or
a linear projection matrix.

8. The apparatus of claim 1, wherein the transformer-based cross-node machine learning system comprises the transmitter neural network instantiated by the UE.

9. The apparatus of claim 1, wherein the transmitter neural network comprises:
a linear projection component that takes, as input, a set of input tokens and generates a set of linear token embeddings corresponding to the set of input tokens, respectively;
a transmitter positional encoding component that takes, as input, the set of linear token embeddings and a task embedding vector, wherein each task embedding vector of a set of task embedding vectors corresponds to one of the one or more CSI feedback tasks, and wherein the transmitter positional encoding component generates a set of token embedding vectors corresponding to the set of linear token embeddings and a position-encoded task embedding vector corresponding to the task embedding vector; and
a transmitter transformer encoder that takes, as input, the set of token embedding vectors and the position-encoded task embedding vector, wherein the transmitter transformer encoder generates a set of transformed token embedding vectors corresponding to the set of token embedding vectors and a transformed task embedding vector corresponding to the position-encoded task embedding vector.

10. The apparatus of claim 1, wherein the transmitter neural network includes an encoder, wherein channel information is used as input to the encoder, and wherein the encoder performs tasks associated with channel state information (CSI) compression.

11. The apparatus of claim 1, wherein the transmitter neural network includes a linear layer, wherein an output task embedding vector is provided, as input to the linear layer, wherein the linear layer computes a lower dimensional latent vector that represents a summary of a set of precoding vectors.

12. The apparatus of claim 11, wherein an output of the linear layer is quantized to a latent vector using a vector quantization component, wherein the latent vector is reported to a network entity, and wherein the latent vector comprises CSI feedback for a particular MIMO stream.

13. An apparatus for wireless communication at a network entity, comprising:
one or more memories; and
one or more processors, coupled to the one or more memories, which, individually or in any combination, are operable to cause the apparatus to:
receive a latent vector from a user equipment (UE), the latent vector corresponding to one or more channel state information (CSI) feedback tasks of a plurality of CSI feedback tasks associated with a transformer-based cross-node machine learning system; and
process the received latent vector using a receiver neural network, wherein the receiver neural network includes a decoder layer that includes a self-attention layer followed by a cross-attention layer that takes a mapped CSI feedback vector as key and value.

14. The apparatus of claim 13, wherein the receiver neural network includes a linear layer, and wherein the linear layer of the receiver neural network maps a latent vector to a mapped embedding vector.

15. The apparatus of claim 14, wherein the receiver neural network includes a receiver transformer decoder that takes, as input, the mapped embedding vector and a set of learned embedding vectors for a particular MIMO stream as precoding vector queries.

16. The apparatus of claim 13, wherein the decoder layer further includes:
a multi-layer perceptron (MLP) that performs a post-processing task.

17. The apparatus of claim 13, wherein the receiver neural network comprises a receiver transformer decoder that processes the received latent vector to generate reconstructed CSI.

18. The apparatus of claim 13, wherein the receiver neural network is configured to handle multiple MIMO streams, with separate processing for each stream.

19. A method of wireless communication performed by a user equipment (UE), comprising:
receiving a transformer configuration that includes a transmitter neural network configured to be used to generate at least one latent vector corresponding to one or more channel state information (CSI) feedback tasks of a plurality of CSI feedback tasks associated with a transformer-based cross-node machine learning system; and
transmitting the at least one latent vector based at least in part on instantiating the transmitter neural network.

20. The method of claim 19, wherein the transmitter neural network includes a transmitter positional encoding component that takes, as input, a set of linear embedding vectors, and wherein the transformer configuration indicates at least one of:
the set of linear embedding vectors, or
an indication of an ordering of the set of task embedding vectors and a set of linear token embeddings.
